(19) United States
(12) Patent Application Publication
(10) Pub. No.: US 2004/0008826 A1
(43) Pub. Date: Jan. 15, 2004

(54) Telephone line dial monitor with wireless transmitter, and external visual indicator with wireless receiver

(76) Inventor: Simon Rakoff, Reston, VA (US)

Correspondence Address: Simon Rakoff, 10906 Quimby Point Ln., Reston, VA, 20191, US

(21) Appl. No.: 10/191,595

(22) Filed: Jul. 10, 2002

(51) Int. Cl. H04M 11/04

(52) U.S. Cl. 379/45; 379/49

(57) ABSTRACT

The telephone line dial monitor with wireless transmitter, and external visual indicator with wireless receiver function together to alert emergency response personnel to the location of an emergency event. Two versions are available, wireless and hard wired. The wireless version connects the line monitor with the external visual indicator by sending a radio signal on an FCC approved frequency. A DPL (digital private line) is included in the transmission so that effectively, each unit is independent of others in the broadcast area. The wired version sends a signal from the line monitor to the external indicator over a wired connection using standard gauge, insulated cable.

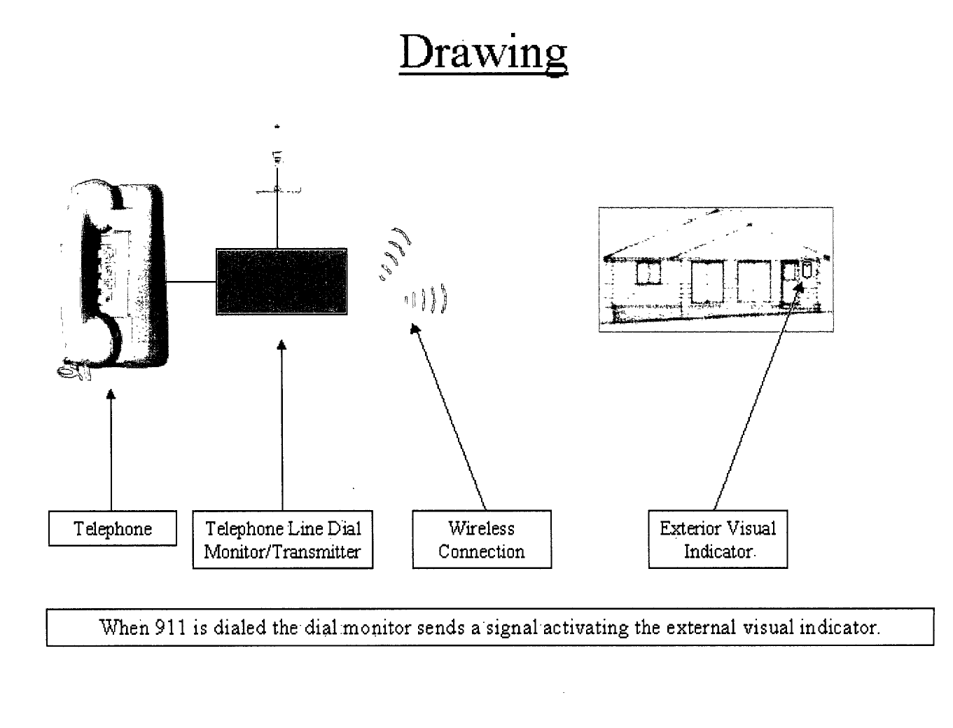

The line monitor is powered by 110 volt AC current with 9 volt battery back up. The external indicator can be powered by 110 volt AC or battery power at the discretion of the consumer.

### CROSS-REFERENCE TO RELATED APPLICATIONS

No related applications have been filed by the named inventor.

### STATEMENT REGARDING FED SPONSORED R&D

No federal funds have been used in the research or development of this invention.

### BACKGROUND OF INVENTION

The device has been developed buy a former fire-fighter and paramedic in order to assist emergency services personnel in locating homes and businesses faster, in the event of life threatening emergencies.

The invention has been inspired by the many deaths associated with delayed response times that are attributable to difficulties in locating the right house, apartment, or business location in a timely manner, when responding to emergency calls.

### SUMMARY OF INVENTION

The invention includes two electronic components:

1) A telephone line dial monitor which identifies when 911 is dialed locally and, 2) an external visual indicator which emits a conspicuous flashing light when activated.

The two electronic devices communicate via a wireless or hardwired connection. In the event that 911 is dialed the visual indicator is activated.

### DESCRIPTION OF DRAWING

The drawing on the following page illustrates the operation of the invention. It shows each component of the invention which are:

Telephone line dial monitor with wireless transmitter (depicted as black box)

External visual indicator with wireless receiver (depicted as yellow cylindrical object on exterior of house)

Also shown are the telephone, the telephone wall jack, and the structure (in this case, a house). These are not to scale. The wireless connection between the two devices is shown using semi-circular concentric lines emanating from the telephone dial monitor. A hard wired connection option is also available.

### DETAILED DESCRIPTION

The invention facilitates faster response time to homes and business locations where emergencies are occurring, by clearly identifying from the outside, which home or office dialed 911.

When the user dials 911 from a touchtone phone, or if 911 is dialed by an automated system such as an alarm, the telephone line dial monitor recognizes the call and sends a signal to the external visual indicator which is immediately activated and begins to flash a conspicuous bright light which is visible for long distances in daylight and darkness.

The user can enter another code from a touchtone phone to deactivate the external visual indicator after help has arrived.

Both units can be powered by either standard voltage AC or by battery. A hardwired connection between the two units is available for instances where the desired distance exceeds the transmitting capabilities of the wireless transmitter.

With regard to the telephone line dial monitor and external visual indicator (the invention) I claim the following:

1- The invention provides an outside visual indicator when 911 is dialed from a telephone at the location of the device.

2- The telephone line dial monitor identifies when 911 is dialed and sends a signal to the external visual indicator.

3- The external visual indicator activates when a signal is received from the telephone line dial monitor. The visual indicator can be deactivated by dialing another code which is detected by the dial monitor.

4- The two electronic components of the invention can be connected by either a wireless or wired connection.
